(19) United States
(12) Patent Application Publication
(10) Pub. No.: US 2011/0305839 A1
(43) Pub. Date: Dec. 15, 2011

(54) OZONE GAS TREATMENT PROCESS AND TREATMENT APPARATUS

(75) Inventors: Hiroshi YANAGIMOTO, Miyoshi-shi (JP); Takeshi BESSHO, Toyota-shi (JP); Atsushi NEMOTO, Kuki-shi (JP); Hiroshi MORITA, Hadano-shi (JP)

(73) Assignees: KURITA WATER INDUSTRIES LTD, Tokyo (JP); TOYOTA JIDOSHA KABUSHIKI KAISHA, Toyota-shi (JP)

(21) Appl. No.: 13/154,889

(22) Filed: Jun. 7, 2011

(30) Foreign Application Priority Data
Jun. 9, 2010 (JP) 2010-132202

(51) Int. Cl. B05D 3/10; B08B 5/00

(52) U.S. Cl. 427/322; 134/34; 134/94.1

(57) ABSTRACT

A process for treating the surface of a resin substrate with an ozone gas by bringing the ozone gas into contact with the surface includes the steps of: generating an ozone gas; humidifying the generated ozone gas; and exposing the surface of the resin substrate to the humidified ozone gas.

### INCORPORATION BY REFERENCE

The disclosure of Japanese Patent Application No. 2010-132202 filed on Jun. 9, 2010 including the specification, drawings and abstract is incorporated herein by reference in its entirety.

### BACKGROUND OF THE INVENTION

1. Field of the Invention

This invention relates to an ozone gas treatment process and treatment apparatus which carry out ozone gas treatment at the surface of a resin substrate by exposing the substrate surface to ozone gas. More particularly, the invention relates to an ozone gas treatment method and treatment apparatus enabling electroless plating to be suitably carried out on a treated substrate surface.

2. Description of Related Art

Electroless plating treatment is available as one method for conferring electrical conductivity and luster to the surface of resin substrates made of polymer resins (substrate surface). Electroless plating treatment is a process whereby metallic ions in a solution are chemically reduced and deposited onto the substrate surface, thereby covering the surface with a metal film (plating film).

Because such electroless plating treatment employs chemical reduction reactions, unlike electroplating which uses electrical power to induce electrolytic deposition, electroless plating is an effective process capable of forming a plating film even on polymeric resin substrate surfaces that generally are electrically insulating.

Moreover, because the substrate surface on which a plating film has been formed is electrically conductive, the electroless-plated substrate surface can be subjected to electroplating via electrolytic deposition. Hence, it is possible to confer a metallic luster to and improve the decorative qualities of resin substrate surfaces used in such fields as automotive parts and electrical appliances.

However, there are cases in which the plating film obtained by electroless plating treatment does not adhere sufficiently to the substrate. Hence, modification of the substrate surface by subjecting the surface to ozone treatment, which is treatment using ozone water (see, for example, Japanese Patent Application Publication No. 2004-131804 (JP-A-2004-131804)) or treatment using ozone gas (see, for example, Japanese Patent Application Publication No. 63-250468 (JP-A-63-250468) and Japanese Patent Application Publication No. 2005-113162 (JP-A-2005-113162)), has been proposed as pretreatment to be carried out prior to plating treatment. Using such ozone treatment, a metal plating can be deposited without roughening the surface of the resin substrate.

However, as indicated in JP-A-2004-131804, for example, when ozone water treatment is carried out on a substrate surface, hydroxyl radicals (.OH) are continuously generated by the reaction of the ozone and water. Because these hydroxyl radicals are strongly oxidizing, the polymer resin continues to break down at the molecular level. Hence, not only is the substrate surface modified, the substrate surface and the resin layers in the vicinity thereof deteriorate, resulting in a loss of strength. This may lead to a decline in the adhesion of the plating film which has been plated onto the substrate surface.

For this reason, it is thought to be effective to carry out ozone gas treatment which does not generate hydroxyl radicals (.OH), such as the treatments described in JP-A-63-250468 and JP-A-2005-113162. However, according to experiments conducted by the inventors, in ozone gas treatment, particularly at low ozone concentrations (e.g., at 50 g/m³ or less), plating did not always deposit on the modified substrate surface, and a plating film did not always form, under these treatment conditions.

Therefore, taking productivity into account, a large apparatus which generates a higher concentration of ozone gas is required. In addition, it takes time for the ozone gas to reach a high concentration. Both of these factors lead to increased production costs.

Moreover, to keep the high-concentration ozone gas from decomposing, the treatment tank where the resin substrate is held and exposed to ozone gas must be surface treated by coating the inner surface of the tank with a fluororesin or the like, which may result in higher equipment costs than before.

### SUMMARY OF THE INVENTION

Accordingly, the invention provides an ozone gas treatment method and treatment apparatus which, in electroless plating treatment, reliably deposit plating and are able to carry out ozone gas treatment on the surface of a resin substrate, both in a short period of time and at low cost.

In humidified ozone gas, the water within the ozone gas is present as tiny particles. Hence, compared with ozone water, a very small amount of hydroxyl radicals is thought to be suspended in the ozone gas. The inventors have discovered that when humidified ozone gas is used to carry out ozone gas treatment, modification of the resin surface which is closer to ozone gas treatment than ozone water treatment can be carried out by the hydroxyl radicals suspended in the ozone gas, in addition to which the substrate surface is more efficiently modified than by conventional ozone gas, enabling plating to be deposited on this surface.

The invention is based on the foregoing novel findings by the inventors. A first aspect of the invention relates to an ozone gas treatment process which includes the steps of generating an ozone gas, humidifying the generated ozone gas, and exposing a surface of a resin substrate to the humidified ozone gas.

In this invention, by humidifying the generated ozone gas, hydroxyl radicals are generated from some of the water suspended in the ozone gas and some of the ozone. These hydroxyl radicals are intermingled with the ozone gas. That is, in cases where, as in the conventional art, ozone has reacted with a liquid such as water drops or an immersion solution, hydroxyl radicals are generated continuously and in a high concentration. However, in the case of humidified ozone gas, the hydroxyl radicals, instead of being concentrated in water, disperse and become suspended in the ozone gas.

As a result, the surface of a resin substrate which has been exposed to humidified ozone gas (which surface is also referred to below as the “substrate surface”), when compared with a substrate surface exposed to ozone water, undergoes substantially no deterioration by hydroxyl radicals, enabling surface modification to be carried out which is similar to conventional ozone gas treatment yet is milder than ozone water treatment.

Moreover, in the case of conventional, unhumidified ozone gas, because hydroxyl radicals are not suspended in the gas, it has been necessary to increase the ozone gas concentration or lengthen the treatment period. However, by using humidified ozone gas, although the ozone gas concentration is lower, it is possible to modify the substrate surface in a short time and at low cost, and to subsequently deposit plating on the substrate surface.

In the above-described humidification of ozone gas, it is preferable for the water suspended in ozone gas to be present in a finer state. For example, the ozone gas can be humidified by mixing vaporized water (fine particles) into the ozone gas at a standard temperature, impregnating a filter with moisture and passing heated ozone gas through the moistened filter, or causing ultrasonic waves to act upon water so as to induce fine particles of water to intermingle with the ozone gas.

In the gas humidifying step, the generated ozone gas may be humidified by passing it through water.

In this arrangement, when ozone gas is passed through water, finer water particles that are finer than in the conventional art become present in the ozone gas. As a result, the hydroxyl radicals generated by the ozone gas and water are not concentrated, and can be uniformly dispersed and suspended in the ozone gas. Moreover, by setting, for example, the amount of water in accordance with the flow rate of ozone gas which is introduced into the water and the length of time the ozone gas is passed through the water, the ozone gas can be humidified to a more precise degree of humidity.

However, when regulating the humidity, an operation may be performed to regulate the amount of water to a value corresponding to the period of time the ozone gas passes through the water. Therefore, the humidification of ozone gas may be carried out by dividing the generated ozone gas into two streams of ozone gas, which have a predetermined flow rate ratio therebetween, passing one of the streams of the ozone gas through water so as to effect the humidification thereof, then recombining the resulting humidified one of the streams of the ozone gas with the other one of the streams of the ozone gas.

In this arrangement, because a portion of the ozone gas is divided off and humidified, and the divided streams of ozone gas are then recombined, the degree of humidity of the ozone gas can easily be regulated.

Moreover, by carrying out electroless plating treatment on the surface of the resin substrate which has been treated in this way with ozone gas and thereby covering the substrate surface with an electroless plating film, it is possible to inexpensively obtain an electroless plating film having a high adhesive strength. Electroless-plated materials on which such an electroless plating film has been formed can be advantageously used in decorative plated parts and engine control unit (ECU) circuit boards.

A second aspect of the invention relates to an ozone gas treatment apparatus which includes a gas generator that generates ozone gas; a gas humidifier that communicates with the gas generator so as to introduce the generated ozone gas into the gas humidifier, and humidifies the introduced ozone gas; and a gas exposure unit that communicates with the gas humidifier so as to introduce the humidified ozone gas into the gas exposure unit, holds therein a resin substrate, and exposes the resin substrate to the humidified ozone gas.

With this arrangement, ozone gas is generated in the gas generator, the generated ozone gas is humidified in the gas humidifier, and the surface of a resin substrate can be exposed to the humidified ozone gas in the gas exposure unit. In this way, a substrate surface that has been exposed to humidified ozone gas can be more mildly surface modified than when immersed in ozone water. Moreover, with humidified ozone gas, even at concentrations lower than the conventional art, it is possible to modify the substrate surface in a short time and at low cost, and to subsequently deposit plating on the substrate surface.

Illustrative examples of such gas humidifiers include humidifiers which use a heater, humidifiers which use the vaporization and dispersion of water in air, and humidifiers which use ultrasonic waves. The type of gas humidifier is not subject to any particular limitation, provided the water suspended in ozone gas can be made finer.

However, the gas humidifier may have at least a receptacle which holds water that humidifies the generated ozone gas in such a way that the generated ozone gas passes through the water. With such an arrangement, by passing the ozone gas through the water in the receptacle, finer water particles than the conventional art are dispersed in the ozone gas, enabling the ozone gas to be rendered into a humidified state. In this way, the hydroxyl radicals generated by ozone gas and water can be dispersed and suspended in ozone gas without being concentrated.

A third aspect of the invention relates to an ozone gas treatment apparatus in which the humidifier includes a gas flow divider that divides the generated ozone gas into two streams of ozone gas which have a predetermined flow rate ratio therebetween; a receptacle that holds water that humidifies one of the streams of the ozone gas such that the one of the streams of the ozone gas passes through the water; and a flow recombiner that recombines the humidified one of the streams of the ozone gas with the other one of the streams of the ozone gas.

In this arrangement, the generated ozone gas is divided at the gas flow divider into two streams of ozone gas which have a predetermined flow rate ratio therebetween. Next, by passing one of the streams of the ozone gas through water in the receptacle, finer water particles than the conventional art are dispersed in the ozone gas, enabling the one of the streams of the ozone gas to be placed in a humidified state. At the flow recombiner, the humidified one of the streams of the ozone gas and the other one of the streams of the ozone gas are then recombined, enabling the humidity of the ozone gas to be regulated.

The receptacle is not subject to any particular limitation, provided it has a structure which is capable of holding water and through which ozone gas can be passed. However, the receptacle may be a tubular receptacle disposed such that the axial direction thereof coincides with a vertical direction, and an inlet that introduces the ozone gas may be formed at a bottom portion of the receptacle and an outlet that discharges the ozone gas may formed at a top portion of the receptacle.

By using such a receptacle, ozone gas is introduced from the bottom portion of the receptacle. The ozone gas which has been introduced into the water held within the receptacle is passed through the water by utilizing the difference in specific gravity between the water and the gas, and is discharged from the top portion of the receptacle.

According to this arrangement, by carrying out ozone gas treatment at the surface of the resin substrate under optimal conditions, reliable plating deposition can be achieved in electroless plating treatment. Moreover, the deposited plating film can have a stable adhesive strength.

### BRIEF DESCRIPTION OF THE DRAWINGS

The features, advantages, and technical and industrial significance of the invention are described below with reference to the accompanying drawings, in which like numerals denote like elements, and wherein:

FIG. 1 is a schematic, conceptual diagram illustrating an ozone gas treatment apparatus according to an embodiment of the invention;

FIG. 2 is a schematic perspective view of the receptacle shown in FIG. 1;

FIG. 3 is a flow chart showing the ozone gas treatment steps and electroless plating treatment steps according to an embodiment of the invention;

FIG. 4 is a graph showing the relationship between the integrated intensity of nitrile bonds at the resin surface as measured by Fourier transform infrared-attenuated total reflection (FT-IR-ATR) spectroscopy versus wavelength for resin surfaces following ozone treatment according to Examples 1 and 2 and Comparative Examples 1 and 2, and for an untreated resin surface; and

FIG. 5 is a graph showing the relationship between integrated intensity of C═O bonds at the resin surface as measured by FT-IR-ATR spectroscopy versus wavelength for resin surfaces following ozone treatment according to Examples 1 and 2 and Comparative Examples 1 and 2, and for an untreated resin surface.

### DETAILED DESCRIPTION OF EMBODIMENTS

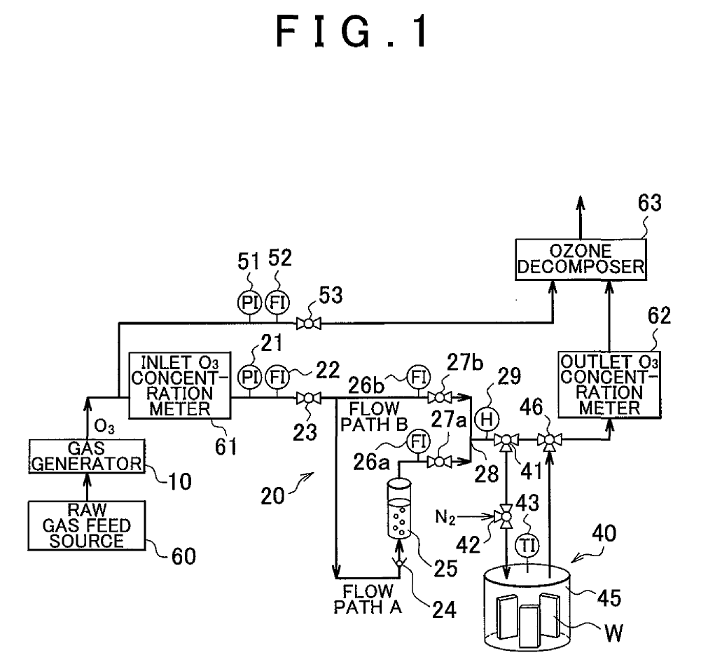

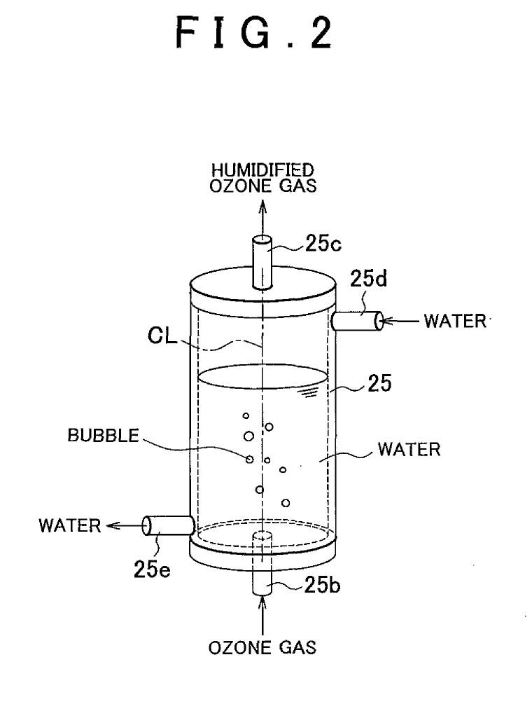

A method for plating a resin substrate, including the ozone gas treatment process according to embodiments of the invention, is described below in conjunction with the appended diagrams and based on embodiments of the invention. FIG. 1 is a schematic conceptual diagram showing an ozone gas treatment apparatus according to the embodiment, and FIG. 2 is a schematic perspective view of the receptacle shown in FIG. 1.

Referring to FIG. 1, an ozone gas treatment apparatus 1 for carrying out the ozone gas treatment of a resin substrate W with humidified ozone gas has at least a gas generator 10, a gas humidifier 20, and a gas exposure unit 40.

The gas generator 10 is connected to a raw gas feed source 60 filled with a mixed gas obtained by mixture from an industrial oxygen gas cylinder and an industrial nitrogen gas cylinder (e.g., a mixed gas containing 5 vol % of nitrogen). The gas generator 10 is constructed so as to generate ozone gas having a desired ozone concentration using raw gas from the raw gas feed source 60. This gas generator 10 is a commonly used ozone gas generator.

The gas humidifier 20 communicates with the gas generator 10 in such a way that generated ozone gas from the gas generator 10 is introduced therein. Specifically, the gas humidifier 20 includes, on the far side of an inlet ozone meter 61 from the gas generator 10: a pressure gauge 21, a flowmeter 22 and a flow-regulating valve 23 which are connected to a distribution line in this order from the upstream side from which the ozone gas flows.

Further downstream from the flow-regulating valve 23, two flow paths A and B are provided so as to divide the ozone gas into two streams. Flow-regulating valves 27a and 27b are connected to the distribution lines on the respective flow paths A and B so as to divide the generated ozone gas into two streams having a predetermined flow rate ratio therebetween. Flowmeters 26a and 26b are attached on the upstream sides of the respective flow-regulating valves 27a and 27b for the purpose of verifying the degree of adjustment in the flow rates by the valves 27a and 27b. In this embodiment, the “flow divider” has a construction which includes at least divided flow paths A and B, and the flow-regulating valves 27a and 27b which regulate flow therethrough.

A receptacle 25 is connected to flow path A through a one-way valve 24. On the downstream side thereof, the above-described flowmeter 26a and flow-regulating valve 27 are connected to the distribution line. As shown in FIG. 2, this receptacle 25 holds water for humidifying the flow-divided ozone gas, in such a way that the ozone gas which flows over flow path A passes through the water.

Specifically, the receptacle 25 is a tubular receptacle which is disposed in such a way that the centerline CL direction (axial direction) of the receptacle 25 coincides with the vertical direction. An inlet 25b for introducing ozone gas is formed at the bottom of the receptacle 25, and an outlet 25c for discharging ozone gas is formed at the top of the receptacle 25.

In addition, if necessary, a water feed port 25d for feeding water to the interior of the receptacle 25 is provided on an upper side of a sidewall of the receptacle 25, and a water discharge port 25e for discharging water from within the receptacle 25 is provided on the lower side of the sidewall. The water feed port 25d and the water discharge port 25e are closed by valves or the like, except during the feeding or discharge of water. In addition, a flow recombiner 28 for recombining the divided streams of ozone gas from flow path A and flow path B is also provided at the gas humidifier 20. A hygrometer 29 is disposed downstream from the flow recombiner 28.

The gas exposure unit 40 is a portion of the ozone gas treatment apparatus whose purpose is to expose the surface of the resin substrate W to the humidified ozone gas. Specifically, three-way valves 41 and 42 serving as on-off valves are connected downstream from the hygrometer 29. The three-way valve 41 and a third three-valve 46 which is connected to the downstream side after the treatment tank 45 are connected to each other so as to be enable a bypass flow path to be formed without passing through the treatment tank 45. The three-way valve 42 is connected to the nitrogen gas source in such a way as to send nitrogen gas to the treatment tank 45.

In addition, a treatment tank 45 is provided downstream of the three-way valve 42. The treatment tank 45 is a vessel which holds the resin substrate W and is sealable so as to enable the resin substrate W to be exposed to the humidified ozone gas. A thermometer 43 for measuring the temperature of the ozone gas during ozone gas treatment is mounted on the treatment tank 45.

Also, an outlet ozone gas thermometer 62 and an ozone decomposer 63 are connected in this order downstream of the gas exposure unit 40. On a separate line (a different line than the above-described line) from the gas generator 10, a pressure gauge 51, a flowmeter 52 and a flow-regulating valve 53 are connected in this order to the distribution line from the upstream side in the direction of ozone gas flow.

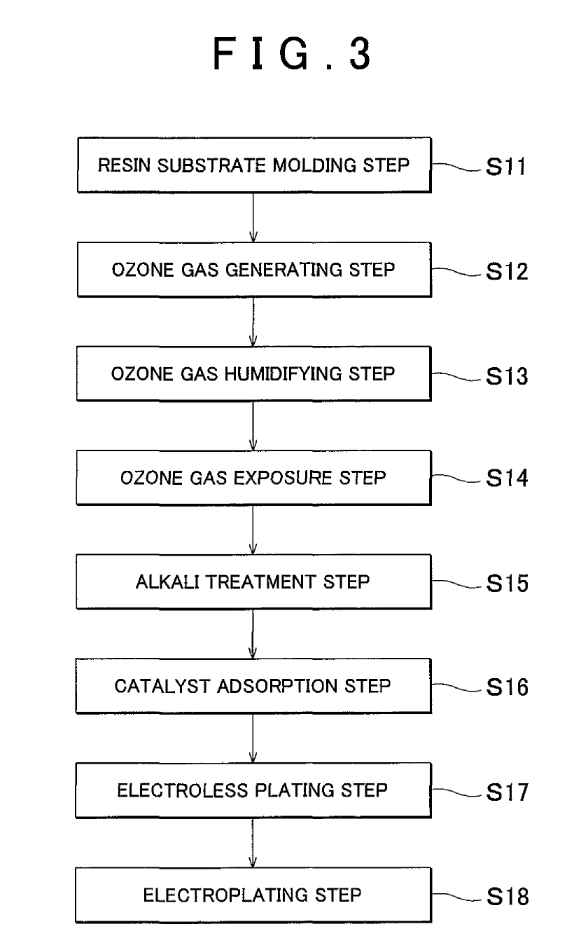

The method of treating ozone gas using the ozone gas treatment apparatus shown in FIGS. 1 and 2 below is described. FIG. 3 is a flow chart for explaining the ozone gas treatment steps and the electroless plating treatment steps according to this embodiment.

As shown in FIG. 3, a molding step S11 is carried out in which a substrate (resin substrate) is molded or otherwise shaped from, for example, a polymer resin having unsaturated bonds, such as Acrylonitrile Butadiene Styrene (ABS) resin. The substrate molding or shaping process is not subject to any particular limitation. Various types of molding or shaping processes may be used, such as compression molding, extrusion, blow molding or injection molding.

The resin substrate is preferably composed of a resin having unsaturated bonds, such as C═C bonds, C═N bonds or C≡C bonds. Examples of resins having such unsaturated bonds that may be selected for use include ABS resins, acrylonitrile-styrene (AS) resins, polystyrene (PS) resins, acrylonitrile (AN) resins, epoxy resins, polymethylmethacrylate (PMMA) resins, polyimide resins and polyphenylsulfide resins.

Next, a series of ozone gas treatment steps, from an ozone gas generating step S12 to an ozone gas exposure step S14, are carried out using the above-described ozone gas treatment apparatus 1. First, the ozone gas generating step S12 is carried out. Specifically, as shown in FIG. 1, ozone gas and nitrogen gas are fed to a raw gas feed source 60, and mixed at the raw gas feed source 60. The mixed raw gases are then fed to the ozone gas generator 10, which generates an ozone gas of the desired ozone concentration and temperature.

Next, the ozone gas humidifying step S13 is carried out. The three-way valves 41 and 46 are adjusted to form a bypass flow path in which these three-way valves 41 and 46 directly communicate with each other. In this state, flow-regulating valves 23, 27a, 27b and 53 are opened, the values at flowmeters 52, 22, 26a 26b and 52 and at pressure gauges 21 and 51 are measured, and the feed ozone gas concentration is measured at the inlet ozone meter 61. While checking these measured values, the valve opening degrees at flow-regulating valves 23, 27a, 27b and 53 are adjusted and the ozone gas that has been fed is divided in such a way as to flow at predetermined flow rates to each of flow paths A and B (flow dividing step).

Of the flow-divided gas, the ozone gas which passes over flow path A is fed into the receptacle 25 from an inlet 25b via a one-way valve 24. At this time, in the receptor 25, because water is held therein, the introduced ozone gas forms into bubbles and moves upward due to the difference in specific gravity with water, becoming humidified as it passes through the water (see FIG. 2). The humidified ozone gas is discharged through discharge port 25c (flow-divided gas humidifying step). Before and after the flow of ozone gas, the feeding of water to and discharge of water from the interior of the receptacle 25 is carried out through water feed port 25d and water discharge port 25e.

In this way, when ozone gas is passed through water, finer water particles that the conventional art are included in the ozone gas. As a result, the hydroxyl radicals generated by ozone gas and water can be uniformly dispersed and suspended in ozone gas without becoming concentrated.

Next, the humidified ozone gas of flow path A and the ozone gas of flow path B are recombined at the flow recombiner 28 (recombining step). Then, using a hygrometer 29, the relative humidity of the recombined ozone gas is measured. At this time, to achieve the desired relative humidity, the flow rate ratio between the flow-divided ozone gases may be further regulated using flow-regulating valves 27a and 27b. Because the flow rate of ozone gas which is introduced into the water is regulated in this way to a desired flow rate, humidification of the ozone gas to a precise relative humidity is possible.

Next, an ozone gas exposure step S14 is carried out. The resin substrate W serving as the workpiece is placed inside the treatment tank 45, the treatment tank 45 is immersed in a water bath (not shown), and the interior of the treatment tank 45 is adjusted to a target gas temperature.

Once adjustment to the target ozone gas concentration, ozone gas temperature and relative humidity that have been selected is complete, the three-way valves 41 and 46 are turned, causing the ozone gas to flow into the treatment tank 45. The ozone gas treatment time at this point is set to a treatment start time of 0 minutes. The temperature within the treatment tank is measured at this time with a thermometer 43 until the selected treatment time is reached, and the ozone gas concentration at the treatment tank output is measured with an outlet ozone meter 62. In this way, humidified ozone gas can be supplied to the surface of the resin substrate W.

Subsequently, once the selected treatment time has been reached, the three-way valves 41 and 42 are turned, sending nitrogen gas into the treatment tank 45. Then, after checking with the outlet ozone meter 62 that the ozone concentration at the outlet of the treatment tank 45 has reached substantially 0 g/Nm³, the treatment tank 45 is opened and the resin substrate is removed. The ozone gas exposure step S14 can be carried out in this way.

As a result, a substrate surface which has been exposed to humidified ozone gas, compared to one which has been exposed to ozone water, undergoes substantially no deterioration due to hydroxyl radicals, enabling surface modification to be carried out, which is close to that of conventional ozone gas treatment and is milder than ozone water treatment.

Moreover, in the case of conventional unhumidified ozone gas, because hydroxyl radicals are not suspended in the gas, it has been necessary to raise the ozone gas concentration or increase the treatment time. However, by using humidified ozone gas, even at a lower ozone gas concentration, the substrate surface can be modified in a short time and at low cost, following which plating can be deposited on the substrate surface.

Once ozone gas treatment method has been carried out as described above, electroless plating treatment is then carried out via a series of steps S15 to S17 on the surface of the resin substrate, thereby covering the substrate surface with an electroless plating film.

First, an alkali treatment step S15 is carried out. In this alkali treatment step S15, an alkali solution containing at least a surfactant is brought into contact with the ozone gas-treated substrate surface. The surfactant, which is for increasing the absorptivity of the subsequently described palladium catalyst, is exemplified by negative ion surfactants such as sodium lauryl sulfate. Examples of the alkali component of the alkali solution include sodium hydroxide, potassium hydroxide and lithium hydroxide. Along with decomposing the surface of the resin substrate at a molecular level and removing the embrittled layer, an alkali metal such as sodium can be imparted to the substrate surface (oxidizing carbonyl groups on the ozone gas-treated substrate surface to a carboxylic acid salt).

In addition, it is desirable to use a polar solvent as the solvent of the surfactant and alkali component-containing solution. Water may typically be used, although an alcohol-type solvent or a water-alcohol mixed solvent may be used in some cases. The alkali solution may be brought into contact with the resin substrate by immersing the resin substrate in a solution or by spraying or otherwise coating the solution onto the substrate surface.

Next, the catalyst adsorption step S16 is carried out. In the catalyst adsorption step S16, the alkali-treated substrate surface is immersed in a catalyst solution (catalyzer) composed of palladium chloride and tin chloride dissolved in aqueous hydrochloric acid. This causes palladium catalyst to be adsorbed onto the surface of the substrate. The substrate surface is then brought into contact with an acidic solution so as to activate the palladium catalyst.

The metal catalyst which is adsorbed onto the surface of the resin substrate composed of a polymer resin is exemplified by such metal catalysts as palladium, silver, cobalt, nickel, ruthenium, cerium, iron, manganese and rhodium, as well as combinations thereof.

Next, an electroless plating treatment step S17 is carried out on the substrate surface to which catalyst has been adsorbed. Specifically, in the electroless plating step S17, the substrate surface to which catalyst has been adsorbed is immersed in a nickel plating solution, causing nickel to be deposited on the surface, and an electroless nickel plating film is thereby formed on the substrate surface which has been subjected to catalyst adsorption treatment. In this way, by carrying out electroless plating treatment on the surface of the resin substrate W that has been ozone gas-treated using humidified ozone gas, the substrate surface is covered with an electroless plating film, thus making it possible to obtain an electroless-plated material having formed thereon an electroless plating film of high adhesive strength.

Next, an electroplating step S18 is carried out on the surface electroless nickel plating film. Specifically, copper plating is deposited by immersing the workpiece in a plating bath, such as a copper sulfate-based electroplating bath, and electroplating.

The embodiments of the invention is described more fully in the following examples, which are illustrative only and are not to be construed as limiting the invention.

### Example 1

First, three test pieces (each measuring 50 mm×100 mm×3 mm, with a handle (10 mm×20 mm×3 mm)) molded from ABS resin were furnished as the resin substrate, and were subjected to batch treatment as described below, up until plating treatment.

<Ozone Gas Treatment Method>

Using an apparatus like the ozone gas treatment apparatus shown in FIG. 1, the above ABS resin substrate was subjected to an exposure treatment step with ozone gas. Using an industrial oxygen gas cylinder and an industrial nitrogen gas cylinder, the oxygen gas and the nitrogen gas were mixed, and the mixed gas (to a nitrogen gas level of 5 vol %) was used as the raw gas of the ozone gas.

Ozone gas was generated using a commercial ozone generator (GR-RD, manufactured by Sumitomo Precision Products Co., Ltd.) as the ozone generator in the inventive apparatus. In order to carry out the standard test shown in Table 1, the mixed gas was regulated and ozone gas was generated at the concentrations in a range of 10 to 100 g/Nm³ shown in Table 1. The generated ozone gas was humidified and made to flow to a reaction vessel (a one-liter all-fluororesin tubular vessel) as the treatment tank. More specifically, the three-way valves 41 and 46 were set so as to cause the ozone gas to flow to the ozone decomposer 63, flow-regulating valves 23 and 27b were opened, and ozone gas of the desire ozone gas concentration was generated at a flow rate of 0.6 NL/min.

Next, the gas flow rate ratio between flow paths A and B was adjusted in order to adjust the ozone gas humidity. Specifically, adjustment was carried out so as to set the ratio between the flow rates of ozone gas through flow paths A and B at 1:1. On flow path A, the flow-divided ozone gas was made to flow to flowmeter 26a and to a transparent polyvinyl chloride column serving as the receptacle 25. On flow path B, the flow-divided ozone gas was made to flow to flowmeter 26b. The flow-divided ozone gas was then recombined at the flow recombiner 28. In this way, ozone gas humidified to 50% relative humidity was obtained. Here, the polyvinyl chloride column was a receptacle having an inside diameter of 120 mm and a height of 1,000 mm. Water was supplied to this receptacle to a water depth of 800 mm.

Next, the resin substrate was placed in the reaction vessel (treatment tank) 45, the reaction vessel 45 was immersed in a water bath (model CA-111 Recirculating Chiller, manufactured by Tokyo Rikakikai Co., Ltd.), and the interior of the reaction vessel was adjusted to the selected temperature. In order to measure the ozone gas concentration within the reaction vessel 45, the inlet ozone gas concentration (feed ozone concentration) and outlet ozone gas concentration (in-tank ozone concentration) were measured by respective ozone meters (the ozone meters used at the inlet and outlet were both EG-600, manufactured by Ebara Jitsugyo Co., Ltd.).

Next, after checking that the outlet ozone meter 62 was at the desired concentration, the three-way valves 41 and 46 were turned, thereby introducing humidified ozone gas to the treatment tank 45. This marked the start of the treatment time. The thermometer 43 was used to check that the reaction vessel 45 remained at a constant temperature. When the treatment time reached 6 minutes, the three-way valve 42 was turned and nitrogen gas was purged for 2 minutes at about 5 NL/min to the reaction vessel 45. After checking with the outlet ozone meter that the ozone gas at the treatment tank outlet had reached substantially 0 g/Nm³, the treatment tank was opened and the resin substrate was removed.

The ozone gas following treatment was decomposed at an ozone decomposer. The ozone decomposer used here was a stainless steel tubular column (made of SUS 304 stainless steel; 150 mm diameter×400 mm height) packed with an ozone-decomposing catalyst (Sekado, available from Shinagawa Chemicals Co., Ltd.).

<Plating Process>

[Alkali Treatment Step]

A mixed aqueous solution containing sodium lauryl sulfate (50 g/L) and NaOH (1 g/L) was prepared. An ozone gas-treated resin substrate made of ABS was immersed for 2 minutes in this mixed aqueous solution set to 50° C., following which the resin substrate was removed from the aqueous solution and rinsed with water.

[Catalyst Adsorption Step]

The alkali-treated resin substrate was immersed, at a treatment temperature of 40° C. and for an immersion time of 4 minutes, in a catalyst solution of palladium chloride (0.1 wt %) and tin chloride (5 wt %) dissolved in aqueous hydrochloric acid (3N). Next, to activate the palladium, the resin substrate was immersed for 2 minutes in aqueous hydrochloric acid (1 N). The temperature of the aqueous hydrochloric acid was set to 50° C. A catalyst was adsorbed in this way onto the surface of the ABS resin substrate. The resin substrate was subsequently removed and rinsed with water.

[Electroless Plating Step]

The resin substrate was immersed for 10 minutes in a Ni—P chemical plating bath (plating bath) held at 30° C., thereby forming a Ni—P plating film on the surface of the resin substrate. A uniform plating deposition was then confirmed on the resin substrate treated in this way. At this time, the thickness of the plating film that had formed was 0.5 μm.

[Electroplating Step]

Next, in a copper sulfate electroplating bath (25° C., 40 minutes), a copper plating film was additionally formed on the electroless Ni—P plating film, thereby covering the electroless Ni—P plating film with a copper plating film. The Ni—P plating film and the copper plating film had a combined thickness of about 30 μm.

### Example 2

An ozone gas treatment method and a plating treatment method were carried out in the same way as in Example 1. This example differed from Example 1 in that, as shown in Table 1, flow division of the ozone gas was not carried out. Instead, ozone gas treatment method was carried by passing the ozone gas only over flow path A, setting the ozone gas to a relative humidity of 95%, and adjusting the voltage applied to the ozone generator so as to set the ozone gas concentration in a range of from 5 to 100 g/Nm³.

### Comparative Example 1

An ozone gas treatment method and a plating treatment method were carried out in the same way as in Example 1. This example differed from Example 1 in that, as shown in Table 1, the ozone gas was not humidified. Instead, ozone gas treatment was carried out by adjusting the voltage applied to the ozone generator so as to set the ozone gas concentration in a range of from 10 to 200 g/Nm³.

### Comparative Example 2

Test pieces were prepared in the same way as in Example 1. This example differed from Example 1 in that 30 ppm ozone water was used instead of ozone gas, with ozone water treatment being carried out by immersing the resin substrate in ozone water at 20° C. for 8 minutes. Comparative Example 2 was a test piece produced for the purpose of measuring the state of the resin substrate surface due to the subsequently described ozone water treatment.

<Adhesive Strength Test>

To evaluate the adhesive strength of the electroless plating film on the resin substrate, tensile tests were carried out in Example 1 and Comparative Example 2 under the following conditions. A plating film on a resin substrate was provided with a 10 mm wide cut and, using these test pieces, the adhesive strength (peel strength) of the plating film was measured in general accordance with JIS H 8630 (Adhesive Test Method). The results are shown in Table 1.

TABLE 1

| | Ozone concentration (g/Nm³) | | | | |
|---|---|---|---|---|---|
| Relative humidity (%) | 5 | 10 | 50 | 100 | 200 |
| Comparative Example 1 | — | no | no | yes | yes |
| 0 | — | — | — | 1.22 | 1.25 |
| Example 1 | — | no | yes | yes | — |
| 50 | — | — | 1.24 | 1.44 | — |
| Example 2 | no | yes | yes | yes | — |
| 95 | — | 1.20 | 1.16 | 1.22 | — |

Top row: Presence/absence of plating deposition (yes/no)
Bottom row: Peel strength (kgf/cm)

<Check Substrate Surface State Before and After Ozone Treatment>

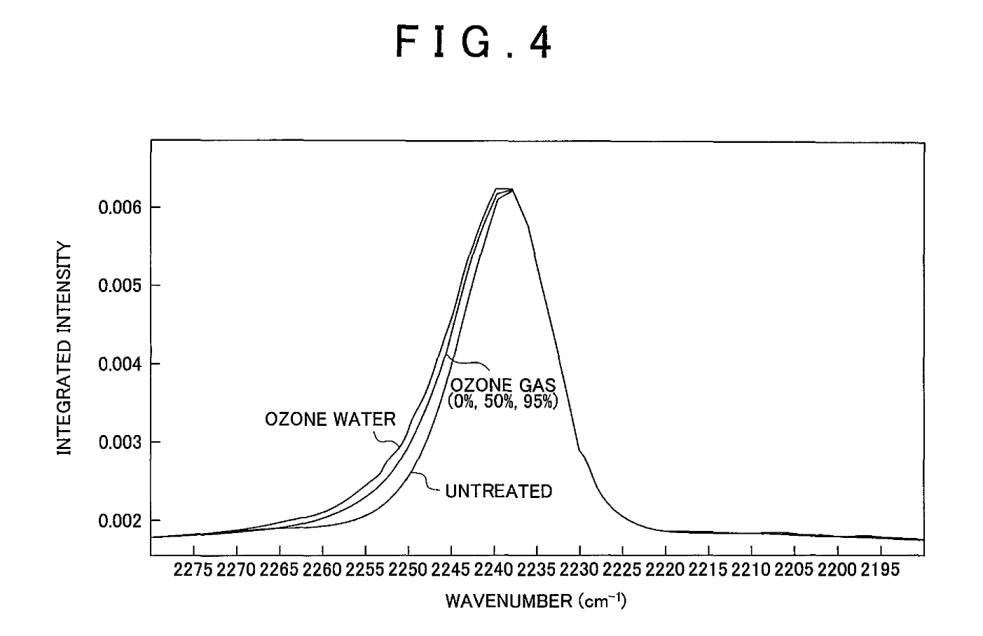

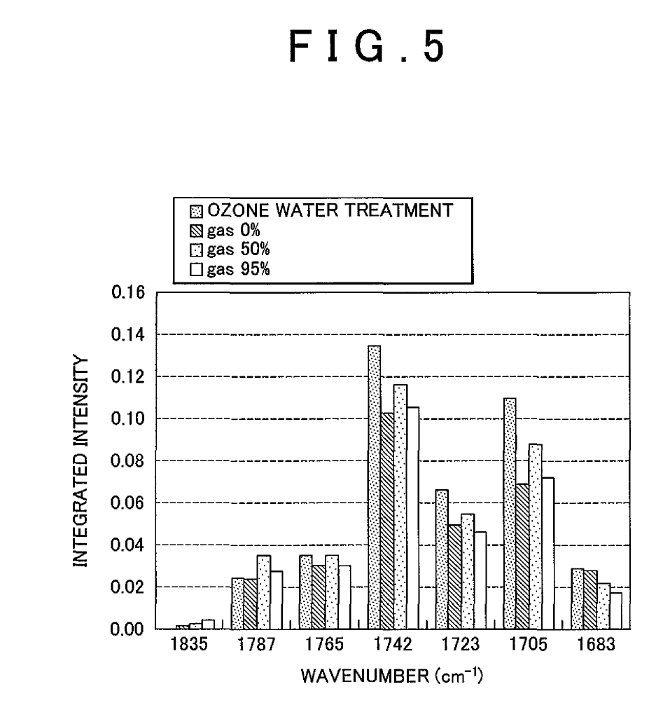

Ozone treatment was carried out at an ozone gas humidity of 50% in Example 1, at an ozone gas humidity of 95% in Example 2, at an ozone gas humidity of 0% in Comparative Example 1 and with ozone water in Comparative Example 2, and the surface of the resin substrate made of ABS resin was measured by FT-IR-ATR spectroscopy. Specifically, analysis was carried out by Fourier transform infrared spectroscopy, and measurement was carried out by the attenuated total reflectance (ATR) method. Here, the measurement apparatus used for ATR was an FT-IR spectrometer manufactured by Varian, the light source was a special ceramic, the detector was a mercury-cadmium-telluride (MCT) detector, purging was carried out with nitrogen gas, the resolution was 4 cm⁻¹, the number of integrations was 512, the method of measurement was ATR, the accessory used was a single reflectance-type ATR accessory (germanium prism; incident angle, 45°). The results are shown in FIGS. 4 and 5.

Here, FIG. 4 is a graph showing the relationship between the integrated intensity of C═N bonds at the resin surface as measured by FT-IR-ATR spectroscopy versus wavelength for resin surfaces following ozone treatment according to Examples 1 and 2 and Comparative Examples 1 and 2, and for an untreated resin surface. FIG. 5 is a graph showing the relationship between the integrated intensity of C=0 bonds at the resin surface as measured by FT-IR-ATR spectroscopy versus wavelength at resin surfaces following ozone treatment according to Examples 1 and 2 and Comparative Examples 1 and 2, and for an untreated resin surface.

Results and Discussion 1

As shown in Table 1, plating was deposited at a lower ozone concentration in Examples 1 and 2 than in Comparative Example 1. Moreover, as shown in Table 1, by humidifying and wetting the ozone gas, the ozone concentration limit value at which plating deposition is possible becomes smaller. Moreover, in Example 2, when treatment was carried out using ozone gas having 95% relative humidity, which is very close to a saturated steam concentration, and a 10 g/Nm³ concentration, plating deposition became possible. Here, plating deposition occurred with one-tenth as much ozone gas as when treatment was carried out with dry ozone gas in Comparative Example 1. Moreover, when the plating adhesion was evaluated, under all conditions at which plating deposition could be carried out, a value of at least 1 kgf/cm was confirmed, demonstrating that a good plating film was obtained.

Results and Discussion 2

As is apparent from FIGS. 4 and 5, the substrate surfaces exposed to ozone gas humidified to a relative humidity of 50% or 95% (Examples 1 and 2, respectively) are in a state close to a substrate surface exposed to ozone gas having a relative humidity of 0% (Comparative Example 1). Moreover, the substrate surface exposed to ozone water (Comparative Example 2) had a higher integrated intensity than the other substrate surfaces, and thus can be regarded as being more modified.

From these results, compared with substrate surface exposed to ozone water, the substrate surfaces in Examples 1 and 2 experienced substantially no deterioration by hydroxyl radicals, leading to the conclusion that surface modification which is close to conventional ozone gas treatment and milder than ozone water treatment is possible.

Embodiments of the invention have been described above in detail. However, the invention is not limited to these embodiments and various design modifications are possible insofar as they do not depart from the gist of the invention.

What is claimed is:

1. An ozone gas treatment process, comprising:
generating an ozone gas;
humidifying the generated ozone gas; and
exposing a surface of a resin substrate to the humidified ozone gas.

2. The process according to claim 1, wherein when the humidification is executed the generated ozone gas is humidified by passing the generated ozone gas through water.

3. The process according to claim 1, wherein when the humidification is executed the generated ozone gas is divided into two streams of the ozone gas which have a predetermined flow rate ratio therebetween, and by passing one of the streams of the ozone gas through water so as to effect humidification thereof; and
the humidified one of the streams of the ozone gas is recombined with the other one of the streams of the ozone gas.

4. A method of manufacturing an electroless-plated material, comprising:
executing the process according to claim 1; and
covering a surface of the ozone gas-treated resin substrate with an electroless plating film by subjecting the surface of the resin substrate to electroless plating treatment.

5. An ozone gas treatment apparatus, comprising:
a gas generator that generates an ozone gas;
a gas humidifier that communicates with the gas generator so as to introduce the generated ozone gas into the gas humidifier, and humidifies the introduced ozone gas; and
a gas exposure unit that communicates with the gas humidifier so as to introduce the humidified ozone gas into the gas exposure unit, holds therein a resin substrate, and exposes the resin substrate to the humidified ozone gas.

6. The ozone gas treatment apparatus according to claim 5, wherein the gas humidifier is a receptacle that holds water that humidifies the generated ozone gas in such a way that the generated ozone gas passes through the water.

7. The ozone gas treatment apparatus according to claim 5, wherein the humidifier comprises:
a gas flow divider that divides the generated ozone gas into two streams of ozone gas which have a predetermined flow rate ratio therebetween;
a receptacle that holds water that humidifies one of the streams of the ozone gas such that the one of the streams of the ozone gas passes through the water; and
a flow recombiner that recombines the humidified one of the streams of the ozone gas with the other one of streams of the ozone gas.

8. The ozone gas treatment apparatus according to claim 6, wherein
the receptacle is a tubular receptacle disposed such that an axial direction thereof coincides with a vertical direction, and
an inlet that introduces the ozone gas is formed at a bottom portion of the receptacle and an outlet that discharges the ozone gas is formed at a top portion of the receptacle.
